(19) United States
(12) Patent Application Publication
(10) Pub. No.: US 2025/0336415 A1
(43) Pub. Date: Oct. 30, 2025

(54) Head Gimbal Assembly With Gimbal Tethers For Hard Disk Drive Device

(71) Applicant: Magnecomp Corporation, Murrieta, CA (US)

(72) Inventor: Kuen Chee Ee, Chino, CA (US)

(21) Appl. No.: 19/184,880

(22) Filed: Apr. 21, 2025

Related U.S. Application Data
(60) Provisional application No. 63/638,341, filed on Apr. 24, 2024.

(51) Int. Cl. G11B 5/48

(52) U.S. Cl. CPC G11B 5/483; G11B 5/4833

(57) ABSTRACT

A head gimbal assembly with a gimbal having a base portion and a tongue that are connected by a neck portion, wherein the tongue includes a first lateral side and a second lateral side opposing the first lateral side, first and second struts connected to the base portion, and a distal portion extending from distal ends of the first and second struts toward the tongue. First and second aft tethers have first ends connected to the first and second lateral sides respectively, and second ends connected to the distal portion. First and second fore tethers have first ends connected to the first and second lateral sides respectively, and second ends connected to the first and second struts respectively. A circuit is mounted on the gimbal. The slider is mounted on the tongue and electrically connected to the circuit.

### CROSS-REFERENCE TO RELATED APPLICATIONS

This application claims the benefit of, and priority to, U.S. Provisional Application No. 63/638,341 filed on Apr. 24, 2024, which is hereby incorporated by reference in its entirety.

### FIELD OF THE INVENTION

The present disclosure relates to hard disk drives, and more particularly to a head gimbal assembly as part of a suspension assembly for hard disk drives.

### BACKGROUND OF THE INVENTION

A hard disk drive (HDD) is a non-volatile storage device that stores digitally encoded data on one or more circular disks having magnetic surfaces. In operation, each disk spins rapidly. Data is read from and written to the disk using a read-write head that is positioned over a specific data track or location on the disk surface by a suspension assembly, which in turn is attached to the arm of the head stack assembly, which is rotated by a voice coil motor or actuator integral to the head stack assembly. Keeping the read-write head stable and aligned with a targeted data track upon the disk surface defines the primary function of the suspension assembly during hard disk drive operation. Optimized suspension assembly design and manufacture can minimize the effects of mechanical, thermal, and other off-track disturbances which can degrade the performance of the hard disk drive. The suspension assembly includes a load beam. In operation, the actuator positions the distal end of the load beam over the desired portion of the disk (e.g., one of the circular tracks on the disk surface). A gimbal assembly (also referred to as a flexure) is mounted on the distal end of the load beam. The gimbal assembly includes components such as a slider containing the read-write head and microactuator devices (piezoelectric devices, also referred to as PZT herein) that rotate a portion of the gimbal assembly for fine positioning of the slider (as opposed to more coarse positioning of the slider by the actuator). The pressure caused by air viscosity between the slider and the spinning disk causes the slider to hover over (in close proximity to) the surface of the disk. While the load beam is relatively stiff, particularly in the lateral axis, the gimbal assembly is more flexible so that the slider can pitch and roll as it floats over the disk surface in order to maintain its operational distance immediately over the disk surface.

FIG. 1 illustrates a portion of a conventional head stack assembly 2, while FIGS. 2 illustrate a conventional head gimbal assembly 10 of the head stack assembly 2. The head stack assembly 2 includes a suspension assembly 3 with a load beam 4 terminating at a proximal end with a hinge 6 that is connected to a baseplate 8. A head gimbal assembly 10 is mounted on the distal end of the load beam 4. The baseplate 8 is connected to an actuator arm 12 of the head stack assembly 2, which is rotated by an integral actuator (not shown).

As best shown in FIG. 2, head gimbal assembly 10 comprises a gimbal 14 of thin components of sheet metal (e.g., stainless steel), a circuit 16 that includes conductive traces (e.g., copper) and insulation material (e.g., polyimide), a slider 18 (that includes a read/write head) mounted on the gimbal 14 (e.g., by adhesive), and PZT actuators 20 mounted to the gimbal 14. Circuit 16 extends along the load beam 4 and head gimbal assembly 10 for electrical signal communication to the read/write head of the slider 18 and to PZT actuators 20. The conductive traces of the circuit 16 are electrically insulated from the gimbal 14 by the insulation material of the circuit 16.

The gimbal 14 includes a base portion 14a and a tongue 14b, which are connected by a neck portion 14c. The tongue 14b is configured to rotate about the neck portion 14c (for fine position control of the slider 18). The slider 18 is mounted on the tongue 14b (i.e., either directly, or indirectly by being mounted on a portion of the circuit 16 which in turn is mounted on the tongue, or a combination of both). The PZT actuators 20 are mounted to the gimbal 14 between the tongue 14b and the base portion 14a, for displacing the tongue 14b about the neck portion 14c and relative to the base portion 14a when the PZT actuators 20 expand and contract in response to electrical signals provided by the circuit 16, which provides fine movement control of the slider 18 relative to the disk tracks during operation. In this example, the PZT actuators 20 are indirectly mounted on the gimbal 14, meaning that the PZT actuators 20 are mounted on the circuit 16, which is in turn mounted on the gimbal 14. However, direct mounting is also possible. Also in this example, the PZT actuators 20 are mounted on the upper side of the gimbal 14 (i.e., the side of the gimbal 14 that faces away from the corresponding disk), and the slider 18 (partially viewable in FIG. 2 through opening 22 of gimbal tongue 14b) is mounted on the lower side of the gimbal 14 (i.e., the side of the gimbal 14 that faces toward the corresponding disk). However, mounting PZT actuators 20 on the lower side of gimbal 14 is also possible.

The gimbal 14 can be attached to the load beam 4 at three welds locations 24, where the gimbal 14 is spot welded to the load beam 4. Two of the spot welds (referred to herein as proximal welds) can be located at a proximal portion 14d of the gimbal 14 (closer to the proximal end of the load beam 4) which includes struts 26, where the proximal welds are located at the proximal ends of the struts 26 of the gimbal 14. The third spot weld (referred to herein as distal weld) is located at a distal portion 14e of the gimbal 14 (for welding distal portion 14e to a distal end of the load beam 4). Distal portion 14e is located at the distal ends of struts 26 (i.e., where the distal ends of struts 26 meet). Connecting portions 26a of struts 26 extend to and connect with base portion 14a.

A pair of tethers 28 can be included between the gimbal 14 and the portion of circuit 16 mounted to the tongue 14b, one on each side of the tongue 14b. Specifically, each tether 28 has a “Y” configuration with a first end connected to the portion of circuit 16 mounted to the tongue 14b, a second end connected to one of the connecting portions 26a of struts 26, and a third end connected to one of the struts 26. The purpose of tethers 28 is to prevent unwanted out-of-plane deflections (i.e., deflections out of the plane of the gimbal 14) of the tongue 14b (and the circuit 16 and slider 18 mounted thereon). For example, the load beam 4 can include a dimple on which the neck portion 14c rests, and the tethers 28 can prevent excessive deflections of the tongue 14b that would cause separation of the neck portion 14c from the dimple during the assembly process or during shock events when the suspension assembly 3 is parked on a ramp in the drive while not in operation. The tethers 28 should be rigid enough in order to effectively prevent excessive out-of-plane deflections. However, tethers 28 should also be flexible enough to allow the tongue 14b to rotate about the neck portion 14c (for fine position control of the slider 18) during operation, to allow the out-of-plane deflection that can occur by contact with the dimple when the gimbal 14 is welded to the load beam, and to allow out-of-plane deflection associated with the non-zero pitch static attitude angle when the suspension assembly 3 is parked on the ramp in the drive. It can be difficult to achieve the desired combination of flexibility and rigidity of the tethers 28.

There is a need for a tether configuration that provides better performance by better balancing flexibility and rigidity of the tethers.

### BRIEF SUMMARY OF THE INVENTION

In some embodiments the aforementioned problems and needs are addressed by a head gimbal assembly comprising a gimbal, a circuit and a slider. In other embodiments a suspension assembly is provided comprising a base plate, load beam and a gimbal mounted on a distal end of the load beam.

The gimbal comprises a base portion and a tongue that are connected by a neck portion, wherein the tongue includes a first lateral side and a second lateral side opposing the first lateral side, a first strut connected to the base portion, a second strut connected to the base portion, and a distal portion extending from distal ends of the first and second struts toward the tongue. A first aft tether has a first end connected to the first lateral side and a second end connected to the distal portion. A second aft tether has a first end connected to the second lateral side and a second end connected to the distal portion. A first fore tether has a first end connected to the first lateral side and a second end connected to the first strut. A second fore tether has a first end connected to the second lateral side and a second end connected to the second strut. The circuit is mounted on the gimbal. The slider is mounted on the tongue, and electrically connected to the circuit.

In some embodiments a head gimbal assembly comprises a gimbal, a circuit and a slider. The gimbal comprises a base portion and a tongue that are connected by a neck portion, a first strut connected to the base portion, a second strut connected to the base portion, and a distal portion extending from distal ends of the first and second struts toward the tongue. The circuit is mounted on the gimbal, wherein the circuit includes a first lateral side and a second lateral side opposing the first lateral side. A first aft tether has a first end connected to the first lateral side and a second end connected to the distal portion. A second aft tether has a first end connected to the second lateral side and a second end connected to the distal portion. A first fore tether has a first end connected to the first lateral side and a second end connected to the first strut. A second fore tether has a first end connected to the second lateral side and a second end connected to the second strut. The slider is mounted on the tongue, and electrically connected to the circuit.

In some embodiments a head gimbal assembly comprises a gimbal, a circuit and a slider. The gimbal comprises a base portion and a tongue that are connected by a neck portion, wherein the tongue includes a first lateral side and a second lateral side opposing the first lateral side, a first strut connected to the base portion, a second strut connected to the base portion, and a distal portion extending from distal ends of the first and second struts away from the tongue. A first aft tether has a first end connected to the first lateral side and a second end connected to the first strut. A second aft tether has a first end connected to the second lateral side and a second end connected to the second strut. A first fore tether has a first end connected to the first lateral side and a second end connected to the first strut. A second fore tether has a first end connected to the second lateral side and a second end connected to the second strut. The circuit is mounted on the gimbal. The slider is mounted on the tongue, and electrically connected to the circuit.

In some embodiments a head gimbal assembly comprises a gimbal, a circuit and a slider. The gimbal comprise a base portion and a tongue that are connected by a neck portion, a first strut connected to the base portion, a second strut connected to the base portion, and a distal portion extending from distal ends of the first and second struts away from the tongue. The circuit is mounted on the gimbal, wherein the circuit includes a first lateral side and a second lateral side opposing the first lateral side. A first aft tether has a first end connected to the first lateral side and a second end connected to the first strut. A second aft tether has a first end connected to the second lateral side and a second end connected to the second strut. A first fore tether has a first end connected to the first lateral side and a second end connected to the first strut. A second fore tether has a first end connected to the second lateral side and a second end connected to the second strut. The slider is mounted on the tongue, and electrically connected to the circuit.

In some embodiments a suspension assembly is provided comprised of a base plate, load beam and a gimbal mounted on a distal end of the load beam. The gimbal comprises a base portion and a tongue that are connected by a neck portion, wherein the tongue includes a first lateral side and a second lateral side opposing the first lateral side, a first strut connected to the base portion, a second strut connected to the base portion, and a distal portion extending from distal ends of the first and second struts away from the tongue. A first aft tether has a first end connected to the first lateral side and a second end connected to the first strut. A second aft tether has a first end connected to the second lateral side and a second end connected to the second strut. A first fore tether has a first end connected to the first lateral side and a second end connected to the first strut. A second fore tether has a first end connected to the second lateral side and a second end connected to the second strut.

Alternatively, a suspension assembly is provided comprised of a base plate, load beam and a gimbal mounted on a distal end of the load beam. The gimbal comprises a base portion and a tongue that are connected by a neck portion, wherein the tongue includes a first lateral side and a second lateral side opposing the first lateral side, a first strut connected to the base portion, a second strut connected to the base portion, and a distal portion extending from distal ends of the first and second struts toward the tongue. A first aft tether has a first end connected to the first lateral side and a second end connected to the distal portion. A second aft tether has a first end connected to the second lateral side and a second end connected to the distal portion. A first fore tether has a first end connected to the first lateral side and a second end connected to the first strut. A second fore tether has a first end connected to the second lateral side and a second end connected to the second strut.

Other objects and features of the present disclosure will become apparent by a review of the specification, claims and appended figures.

### BRIEF DESCRIPTION OF THE DRAWINGS

FIG. 1 is a partial perspective view of a conventional head stack assembly.

FIG. 2 is a top view of a conventional head gimbal assembly.

FIG. 3 is a bottom view of an example gimbal assembly.

FIG. 4 is a bottom view of a second example gimbal assembly.

FIG. 5 is a bottom view of a third example gimbal assembly.

FIG. 6 is a bottom view of a fourth example gimbal assembly.

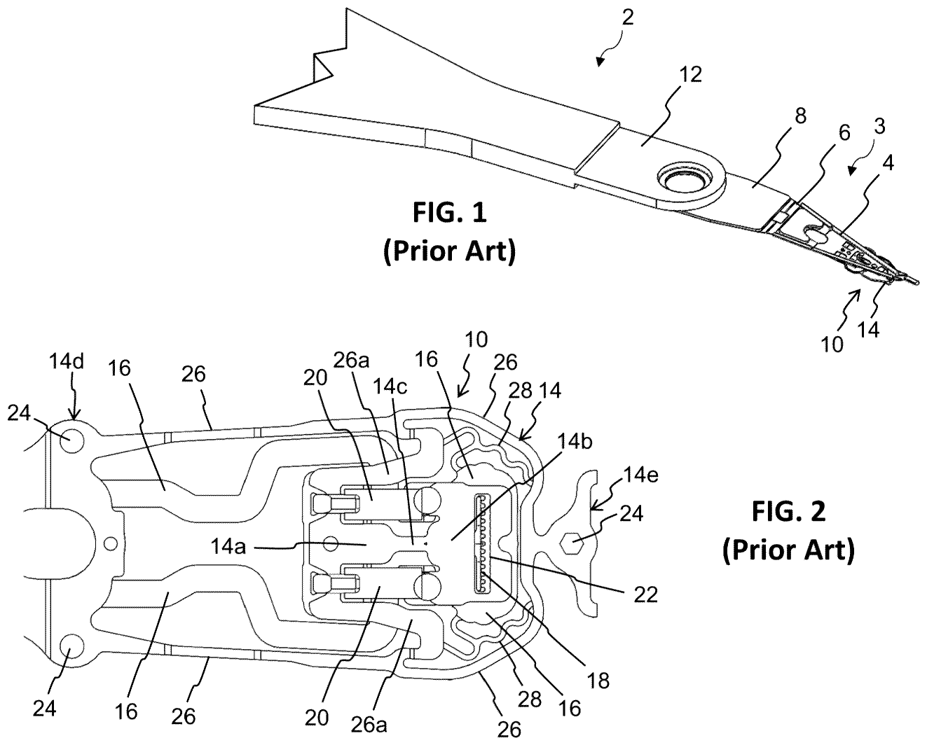

### DETAILED DESCRIPTION OF THE INVENTION

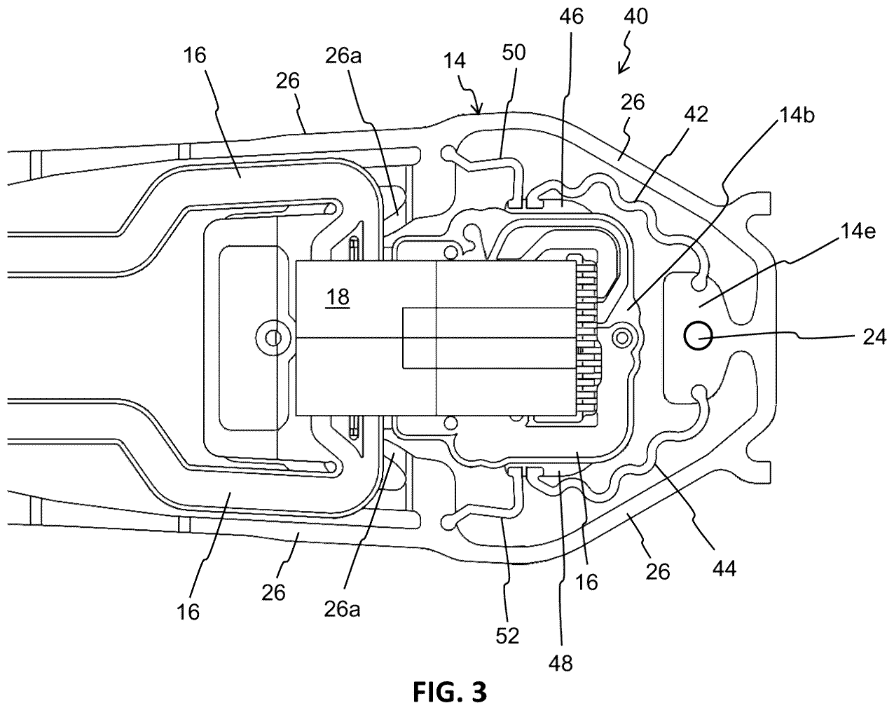

It has been discovered by the present inventor that better performance can be achieved by using a gimble with a tether configuration that includes four separate tethers extending from the tongue. FIG. 3 illustrates an example head gimbal 40 of a suspension assembly or head gimbal assembly that is similar to that of FIG. 2 (with like elements marked with the same reference numbers), but with an improved tether configuration.

In the example of FIG. 3, the distal portion 14e of gimbal 14 extends from the distal ends of struts 26 (i.e., where they meet) toward the tongue 14b, instead of away from the tongue 14b as shown in FIG. 2. There are two separate and distinct tethers on each of two opposing lateral sides of the tongue 14b. Specifically, a first aft tether 42 has a first end connected to a first lateral side 46 of the tongue 14b and a second end connected to the distal portion 14e of gimbal 14. A second aft tether 44 has a first end connected to a second lateral side 48 of the tongue 14b and a second end connected to the distal portion 14e of gimbal 14. A first fore tether 50 has a first end connected to the first lateral side 46 of the tongue 14b and a second end connected to one of the struts 26. A second fore tether 52 has a first end connected to the second lateral side 48 of the tongue 14b and a second end connected to the other one of the struts 26. Each of the aft tethers 42, 44 and fore tethers 50, 52 include one or more in-plane bends (i.e., bends in the plane of the gimbal 14) for increased in-plane flexibility to accommodate the displacing of the tongue 14b about the neck portion 14c and relative to the base portion 14a when the PZT actuators 20 expand and contract.

Having two separate tethers (one aft tether 42 or 44, and one fore tether 50 or 52) on each lateral side of the tongue has many advantages. It minimizes the stiffness interaction between tether connections to the distal portion 14e and to the struts 26. The aft tethers 44, 44 can be more flexible (e.g., by having a longer length and a greater number of bends relative to the number of bends in the fore tethers 50, 52) so as to have less impact on the out-of-plane flexibility, while the fore tethers 50, 52 can be more rigid (e.g., by having a shorter length and fewer bends relative to the aft tethers 42, 44) for out-of-plane deflection performance improvement. Further, the fore tethers 50, 52 can provide increased in-plane stiffness of the tongue 14b relative to base portion 14a in order to increase the yaw frequency without significantly impacting overall gimble stiffness. The geometry of having distal portion 14e of gimbal extending from distal ends of struts 26 toward tongue 14b provides more empty space for the aft tethers 42 and 44, and longer aft tethers 42 and 44 can be created between the tongue 14b and the distal portion 14e for additional flexibility as needed.

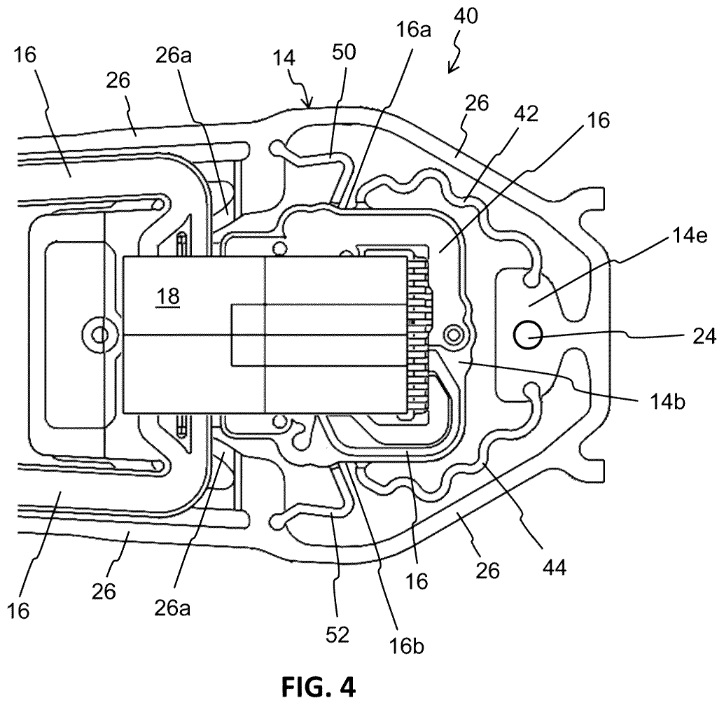

FIG. 4 illustrates another example head gimbal 40, which is the same as the head gimbal 40 of FIG. 3, except that the aft and fore tethers are connected the circuit 16 (which is mounted to the tongue 14b) instead of being connected to the tongue. Specifically, first aft tether 42 has a first end connected to a first lateral side 16a of circuit 16 and a second end connected to the distal portion 14e of gimbal 14. Second aft tether 44 has a first end connected to a second lateral side 16b of circuit 16 and a second end connected to the distal portion 14e of gimbal 14. First fore tether 50 has a first end connected to the first lateral side 16a of circuit 16 and a second end connected to one of the struts 26. Second fore tether 52 has a first end connected to the second lateral side 16b of circuit 16 and a second end connected to the other one of the struts 26. Because circuit 16 is mounted to the tongue 14b, the forces imparted onto the circuit 16 (by the first and second aft tethers 42, 44 and the first and second fore tethers 50, 52) are indirectly imparted onto the tongue 14b. Connecting the tethers 42, 44, 50, 52 to the circuit 16 instead of to the tongue 14b allows for the tongue 14b to be smaller and have lower mass for better performance.

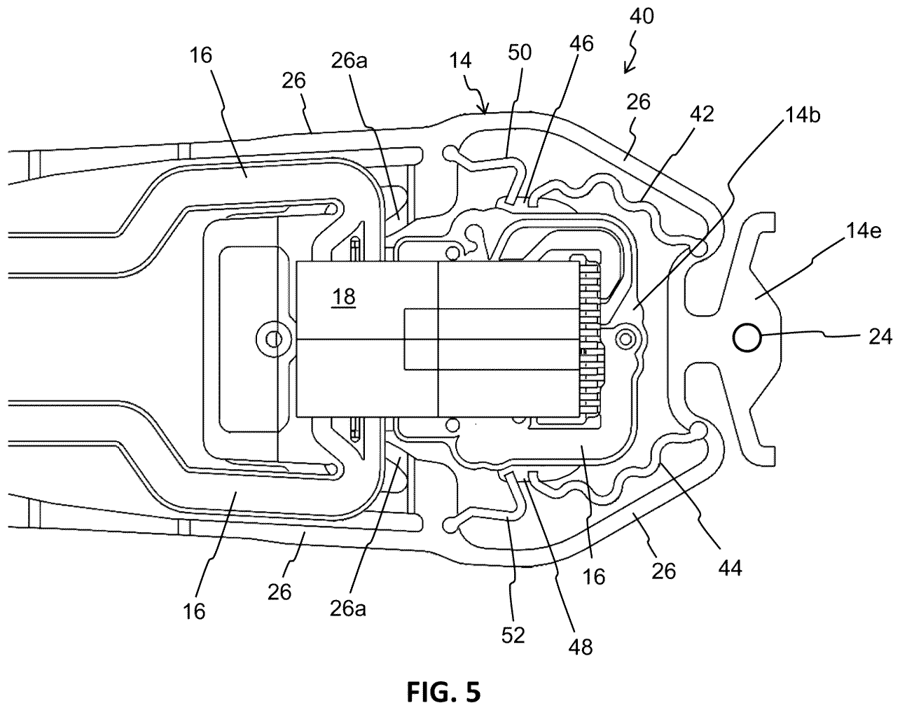

FIG. 5 illustrates another example head gimbal 40, which is the same as the head gimbal 40 of FIG. 3, except that the distal portion 14e of gimbal 14 extends from the distal ends of struts 26 (i.e., where they meet) away from the tongue 14b, instead of toward the tongue 14b as shown in FIG. 3. With this configuration, the second end of first aft tether 42 is connected to one of the struts 26 (instead of to the distal portion 14e of gimbal 14), and the second end of the second aft tether 44 is connected to the other one of the struts 26 (instead of to the distal portion 14e of gimbal 14). Having the distal portion 14e of gimbal 14 extending away from the tongue 14b is advantageous for suspension designs with the distal weld located further away from the tongue 14b.

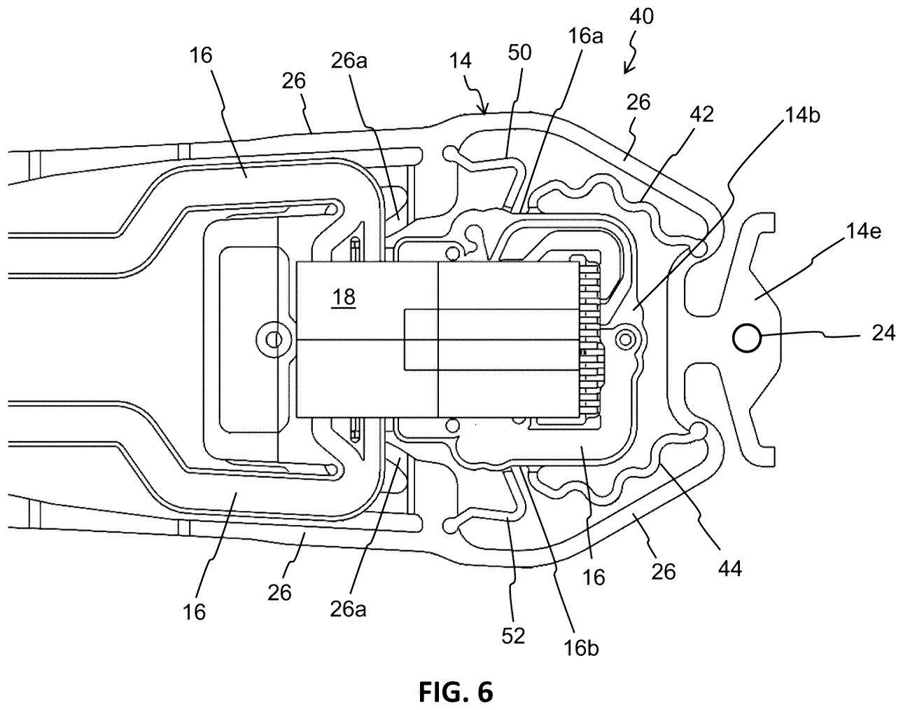

FIG. 6 illustrates another example head gimbal assembly 40, which is the same as the head gimbal assembly 40 of FIG. 4, except that the distal portion 14e of gimbal 14 extends from the distal ends of struts 26 (i.e., where they meet) away from the tongue 14b, instead of toward the tongue 14b as shown in FIG. 4. With this configuration, the second end of first aft tether 42 is connected to one of the struts 26 (instead of to the distal portion 14e of gimbal 14), and the second end of the second aft tether 44 is connected to the other one of the struts 26 (instead of to the distal portion 14e of gimbal 14).

It is to be understood that the present disclosure is not limited to the example(s) described above and illustrated herein, but encompasses any and all variations falling within the scope of any claims. References to the present invention, embodiments or examples herein are not intended to limit the scope of any claim or claim term, but instead merely make reference to one or more features that may be covered by one or more of the claims. Materials, processes and numerical examples described above are exemplary only, and should not be deemed to limit the claims.

What is claimed is:

1. A head gimbal assembly comprising:
a gimbal comprising:
a base portion and a tongue that are connected by a neck portion, wherein the tongue includes a first lateral side and a second lateral side opposing the first lateral side,
a first strut connected to the base portion,
a second strut connected to the base portion, and
a distal portion extending from distal ends of the first and second struts toward the tongue;
a first aft tether having a first end connected to the first lateral side and a second end connected to the distal portion;
a second aft tether having a first end connected to the second lateral side and a second end connected to the distal portion;
a first fore tether having a first end connected to the first lateral side and a second end connected to the first strut;
a second fore tether having a first end connected to the second lateral side and a second end connected to the second strut;
a circuit mounted on the gimbal; and
a slider mounted on the tongue, and electrically connected to the circuit.

2. The head gimbal assembly of claim 1, comprising:
a first PZT actuator and a second PZT actuator mounted to the head gimbal assembly and electrically connected to the circuit, for displacing the tongue relative to the base portion.

3. The head gimbal assembly of claim 1, wherein:
the first aft tether includes a plurality of bends; and
the second aft tether includes a plurality of bends.

4. The head gimbal assembly of claim 1, wherein:
the first aft tether includes a first plurality of bends;
the second aft tether includes a second plurality of bends;
the first fore tether includes a third plurality of bends;
the second fore tether includes a fourth plurality of bends;
the first plurality of bends is greater in number than the third plurality of bends; and
the second plurality of bends is greater in number than the fourth plurality of bends.

5. The head gimbal assembly of claim 1, wherein:
the first aft tether has a length that is greater than a length of the first fore tether; and
the second aft tether has a length that is greater than a length of the second fore tether.

6. A head gimbal assembly comprising:
a gimbal comprising:
a base portion and a tongue that are connected by a neck portion,
a first strut connected to the base portion,
a second strut connected to the base portion, and
a distal portion extending from distal ends of the first and second struts toward the tongue;
a circuit mounted on the gimbal, wherein the circuit includes a first lateral side and a second lateral side opposing the first lateral side;
a first aft tether having a first end connected to the first lateral side and a second end connected to the distal portion;
a second aft tether having a first end connected to the second lateral side and a second end connected to the distal portion;
a first fore tether having a first end connected to the first lateral side and a second end connected to the first strut;
a second fore tether having a first end connected to the second lateral side and a second end connected to the second strut; and
a slider mounted on the tongue, and electrically connected to the circuit.

7. The head gimbal assembly of claim 6, comprising:
a first PZT actuator and a second PZT actuator mounted to the head gimbal assembly and electrically connected to the circuit, for displacing the tongue relative to the base portion.

8. The head gimbal assembly of claim 6, wherein:
the first aft tether includes a plurality of bends; and
the second aft tether includes a plurality of bends.

9. The head gimbal assembly of claim 6, wherein:
the first aft tether includes a first plurality of bends;
the second aft tether includes a second plurality of bends;
the first fore tether includes a third plurality of bends;
the second fore tether includes a fourth plurality of bends;
the first plurality of bends is greater in number than the third plurality of bends; and
the second plurality of bends is greater in number than the fourth plurality of bends.

10. The head gimbal assembly of claim 6, wherein:
the first aft tether has a length that is greater than a length of the first fore tether; and
the second aft tether has a length that is greater than a length of the second fore tether.

11. A head gimbal assembly comprising:
a gimbal comprising:
a base portion and a tongue that are connected by a neck portion, wherein the tongue includes a first lateral side and a second lateral side opposing the first lateral side,
a first strut connected to the base portion,
a second strut connected to the base portion, and
a distal portion extending from distal ends of the first and second struts away from the tongue;
a first aft tether having a first end connected to the first lateral side and a second end connected to the first strut;
a second aft tether having a first end connected to the second lateral side and a second end connected to the second strut;
a first fore tether having a first end connected to the first lateral side and a second end connected to the first strut;
a second fore tether having a first end connected to the second lateral side and a second end connected to the second strut;
a circuit mounted on the gimbal; and
a slider mounted on the tongue, and electrically connected to the circuit.

12. The head gimbal assembly of claim 11, comprising:
a first PZT actuator and a second PZT actuator mounted to the head gimbal assembly and electrically connected to the circuit, for displacing the tongue relative to the base portion.

13. The head gimbal assembly of claim 11, wherein:
the first aft tether includes a plurality of bends; and
the second aft tether includes a plurality of bends.

14. The head gimbal assembly of claim 11, wherein:
the first aft tether includes a first plurality of bends;
the second aft tether includes a second plurality of bends;
the first fore tether includes a third plurality of bends;
the second fore tether includes a fourth plurality of bends;
the first plurality of bends is greater in number than the third plurality of bends; and
the second plurality of bends is greater in number than the fourth plurality of bends.

15. The head gimbal assembly of claim 11, wherein:
the first aft tether has a length that is greater than a length of the first fore tether; and
the second aft tether has a length that is greater than a length of the second fore tether.

16. A head gimbal assembly comprising:
a gimbal comprising:
a base portion and a tongue that are connected by a neck portion,
a first strut connected to the base portion,
a second strut connected to the base portion, and
a distal portion extending from distal ends of the first and second struts away from the tongue;
a circuit mounted on the gimbal, wherein the circuit includes a first lateral side and a second lateral side opposing the first lateral side;
a first aft tether having a first end connected to the first lateral side and a second end connected to the first strut;
a second aft tether having a first end connected to the second lateral side and a second end connected to the second strut;
a first fore tether having a first end connected to the first lateral side and a second end connected to the first strut;
a second fore tether having a first end connected to the second lateral side and a second end connected to the second strut; and
a slider mounted on the tongue, and electrically connected to the circuit.

17. The head gimbal assembly of claim 16, comprising:
a first PZT actuator and a second PZT actuator mounted to the head gimbal assembly and electrically connected to the circuit, for displacing the tongue relative to the base portion.

18. The head gimbal assembly of claim 16, wherein:
the first aft tether includes a plurality of bends; and
the second aft tether includes a plurality of bends.

19. The head gimbal assembly of claim 16, wherein:
the first aft tether includes a first plurality of bends;
the second aft tether includes a second plurality of bends;
the first fore tether includes a third plurality of bends;
the second fore tether includes a fourth plurality of bends;
the first plurality of bends is greater in number than the third plurality of bends; and
the second plurality of bends is greater in number than the fourth plurality of bends.

20. The head gimbal assembly of claim 16, wherein:
the first aft tether has a length that is greater than a length of the first fore tether; and
the second aft tether has a length that is greater than a length of the second fore tether.

21. A suspension assembly, comprising a base plate;
a load beam connected to the baseplate at a proximal end of the load beam;
a gimbal mounted on the distal end of the load beam, the gimbal comprising:
a base portion and a tongue that are connected by a neck portion, wherein the tongue includes a first lateral side and a second lateral side opposing the first lateral side,
a first strut connected to the base portion,
a second strut connected to the base portion, and
a distal portion extending from distal ends of the first and second struts toward the tongue;
a first aft tether having a first end connected to the first lateral side and a second end connected to the distal portion;
a second aft tether having a first end connected to the second lateral side and a second end connected to the distal portion;
a first fore tether having a first end connected to the first lateral side and a second end connected to the first strut; and
a second fore tether having a first end connected to the second lateral side and a second end connected to the second strut.

22. The suspension assembly of claim 21, wherein:
the first aft tether includes a plurality of bends; and
the second aft tether includes a plurality of bends.

23. The suspension assembly of claim 21, wherein:
the first aft tether includes a first plurality of bends;
the second aft tether includes a second plurality of bends;
the first fore tether includes a third plurality of bends;
the second fore tether includes a fourth plurality of bends;
the first plurality of bends is greater in number than the third plurality of bends; and
the second plurality of bends is greater in number than the fourth plurality of bends.

24. The suspension assembly of claim 21, wherein:
the first aft tether has a length that is greater than a length of the first fore tether; and
the second aft tether has a length that is greater than a length of the second fore tether.

25. A suspension assembly comprising:
a base plate;
a load beam connected to the baseplate at a proximal end of the load beam;
a gimbal mounted on the distal end of the load beam, the gimbal comprising:
a base portion and a tongue that are connected by a neck portion, wherein the tongue includes a first lateral side and a second lateral side opposing the first lateral side,
a first strut connected to the base portion,
a second strut connected to the base portion, and
a distal portion extending from distal ends of the first and second struts away from the tongue;
a first aft tether having a first end connected to the first lateral side and a second end connected to the first strut;
a second aft tether having a first end connected to the second lateral side and a second end connected to the second strut;
a first fore tether having a first end connected to the first lateral side and a second end connected to the first strut; and
a second fore tether having a first end connected to the second lateral side and a second end connected to the second strut.

26. The suspension assembly of claim 25, wherein:
the first aft tether includes a plurality of bends; and
the second aft tether includes a plurality of bends.

27. The suspension assembly of claim 25, wherein:
the first aft tether includes a first plurality of bends;
the second aft tether includes a second plurality of bends;
the first fore tether includes a third plurality of bends;
the second fore tether includes a fourth plurality of bends;
the first plurality of bends is greater in number than the third plurality of bends; and
the second plurality of bends is greater in number than the fourth plurality of bends.

28. The suspension assembly of claim 25, wherein:
the first aft tether has a length that is greater than a length of the first fore tether; and
the second aft tether has a length that is greater than a length of the second fore tether.
